(19) United States
(12) Patent Application Publication
(10) Pub. No.: US 2008/0295704 A1
(43) Pub. Date: Dec. 4, 2008

(54) HOT CEREAL MAKER AND RELATED METHODS

(76) Inventors: Charles R. ROSE, III, Orlando, FL (US); Michael R. Booker, Madison Heights, VA (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/131,382

(22) Filed: Jun. 2, 2008

Related U.S. Application Data
(60) Provisional application No. 60/941,203, filed on May 31, 2007.

(51) Int. Cl. A47J 36/16; B01F 7/04; A23L 1/168

(52) U.S. Cl. 99/348; 366/167.2; 366/343; 99/339

(57) ABSTRACT

A hot cereal maker includes a housing with a basin defined therein for accommodating cereal grains, and a paddle disposed within the housing and operable to mix the cereal grains. The housing includes a base and a lid movable relative thereto, the basin being defined within the base and the paddle being connected to the lid. A mixing apparatus includes a housing having a basin defined therein, a paddle disposed within the basin having a channel, and at least one opening communicating between the channel and the basin, defined therein. A fluid conduit is included in the housing for supplying fluid from a fluid source to the channel. A mixing paddle includes a shaft having a channel defined centrally therein, and a plurality of openings extending through the shaft to the channel also defined therein. At least one vane extends from the shaft.

### CROSS-REFERENCE TO RELATED APPLICATION

This application claims the benefit of U.S. Provisional Application Ser. No. 60/941,203, filed on May 31, 2007, the contents of which are hereby incorporated by reference in their entirety.

### FIELD OF THE INVENTION

The present invention relates to devices for the preparation of hot cereal and related methods.

### BACKGROUND OF THE INVENTION

Various forms of hot cereal have been a staple foodstuff for various cultures for centuries. For instance, cream of wheat, oatmeal and grits are all traditionally popular within the United States, and are often welcomed as a happy change of pace from ubiquitous cold cereals.

Given the hectic nature of day-to-day life, however, many people opt for cold cereal because it generally requires very little preparation time. Hot cereal, on the other hand, usually requires the boiling, or at least heating, of water and some predetermined time for the hot cereal grains to soak in the hot water.

Partially pre-cooked, or “instant,” hot cereals are offered, requiring less cooking time than uncooked varieties. However, instant cereals still require more preparation time than cold cereal, and many hot cereal enthusiasts dislike the flavor of instant cereals.

One possible solution for integrating the consumption of hot cereals into the busy, modern lifestyle is to contrive a device for automatically preparing the hot cereal. Examples of attempts at this type of solution can be found in U.S. Pat. No. 4,899,648 and U.S. Patent Application Publication No. 2003/0037681, the contents of which are hereby incorporated by reference in their entirety. The cereal grain cooking apparatus and system of these references endeavor to automatically supply both the liquid and the grains for hot cereal. However, complex and bulky equipment is required, rendering the apparatus impractical for small-scale or home use, and would render the apparatus or system difficult to break-down, clean and store.

Another example can be found in U.S. Pat. No. 5,233,916, the contents of which are hereby incorporated by reference in their entirety. While this device allows for a relatively compact configuration, there is no provision for the automatic addition of water. Instead, water must be manually added along with the cereal grains. Thus, to achieve optimal results, the hot cereal must be cooked shortly after the manual addition of ingredients.

### SUMMARY OF THE INVENTION

Based in part on the foregoing, it is an object of the present invention to provide an improved hot cereal maker and related methods.

According to an embodiment of the present invention, a hot cereal maker includes a housing with a basin defined therein for accommodating cereal grains, and a paddle disposed within the housing and operable to mix the cereal grains. The housing includes a base and a lid movable relative thereto, the basin being defined within the base and the paddle being connected to the lid.

According to an aspect of the present invention, a mixing apparatus includes a housing having a basin defined therein, a paddle disposed within the basin having a channel, and at least one opening communicating between the channel and the basin, defined therein. A fluid conduit is included in the housing for supplying fluid from a fluid source to the channel.

According to another aspect of the present invention, a mixing paddle includes a shaft having a channel defined centrally therein, and a plurality of openings extending through the shaft to the channel also defined therein. At least one vane extends from the shaft.

According to a method aspect of the present invention, a method of preparing hot cereal includes adding cereal grains to a basin for a desired number of servings, inserting a paddle into the basin, and adding fluid to the cereal grains through the paddle.

These and other objects, aspects and advantages of the present invention will be better understood in view of the drawings and following description of a preferred embodiment.

### BRIEF DESCRIPTION OF THE DRAWINGS

FIG. 1 is a schematic perspective view of a hot cereal maker, according to an embodiment of the present invention; and

FIG. 2 is a sectional view of the hot cereal maker of FIG. 1, taken along the line 2-2, with hidden components and alternate positions shown in broken lines.

### DETAILED DESCRIPTION OF A PREFERRED EMBODIMENT

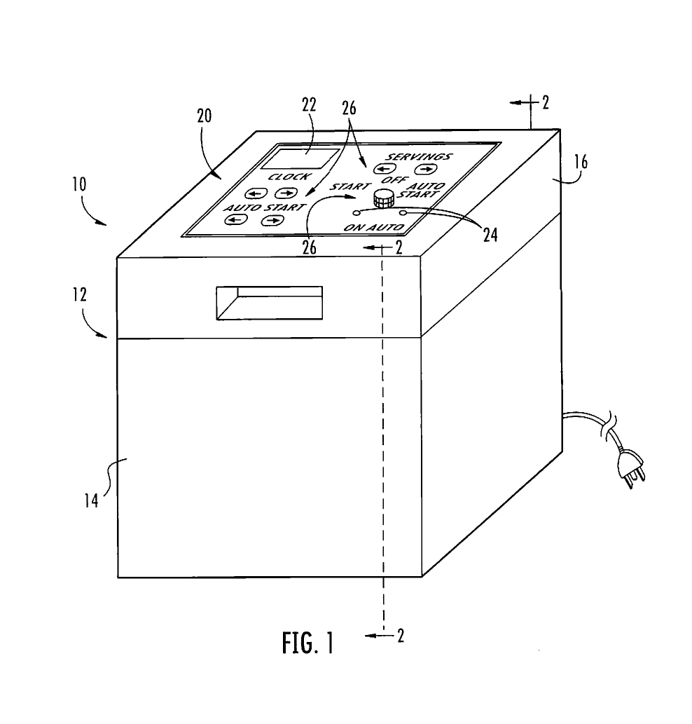

Referring to FIG. 1, according to an embodiment of the present invention, a hot cereal maker 10 includes a housing 12. The housing 12 has a base 14 and a lid 16 moveable relative thereto. A control section 20 is arranged on the housing, for example on the lid 16.

The control section 20 includes a display 22, indicator lights 24 and a plurality of controls 26. The display 22 is operable to visually indicate, for example, a current time, an automatic cooking start time, a set number of servings, a cooking temperature, a cooking time, or the like. The indicator lights 24 are operable to visually indicate the status of the hot cereal maker 10, for instance to indicate that the maker 10 is currently on or is set to automatically operate in the future. The controls 26 allow control of functions such as setting a current time, setting an automatic start time, setting a number of servings, turning the maker 10 on, setting the maker 10 to automatically start at a predetermined future time or the like.

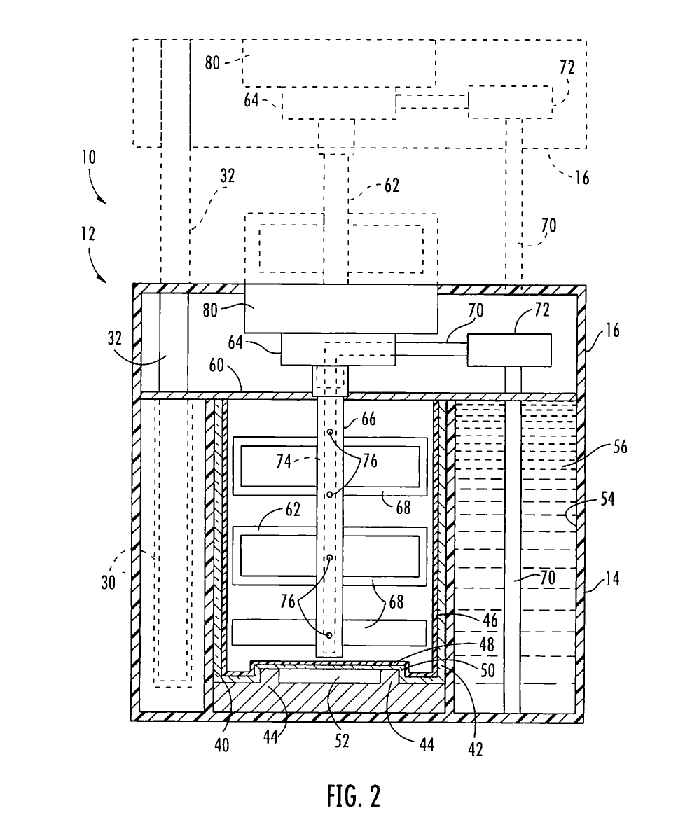

Referring to FIG. 2, the base 14 has sleeves 30 defined therein for accommodating legs 32. The legs 32 are connected to the lid 16 and are slidable within the sleeves 30 (only one of each shown in FIG. 2) such that the lid 16 may be displaced upwards and locked in a raised position (shown in broken lines) relative to the base 14.

A basin 40 is formed within the base 14 that closely accommodates a removable cooking vessel 42, for instance formed of glass, therein. Protrusions 44 extend into the basin 40 and engage the cooking vessel 42 to prevent rotation of the cooking vessel 42 relative to the basin 40. A disposable liner 46 is disposable within the cooking vessel 42. Engagement between respective sections 48, 50 of the vessel 42 and liner 46 prevent rotation therebetween.

A heating element 52 is arranged in the base 14 at the bottom of the basin 40 for transferring heat into a cereal mixture within the basin. A fluid reservoir 54 is also formed within the base 14 for accommodating a fluid 56, such as water or milk, therein.

The lid 16 includes a cover 60 for sealingly enclosing the basin 40 when the lid 16 is lowered onto the base 14. A paddle 62 extends through the cover 60 and is releasably connected to a paddle motor 64 by a quick disconnect or other releasable mechanism. The paddle motor 64 is operable to impart rotational motion to the paddle 62. The paddle 62 has a shaft 66 and a plurality of vanes 68.

A fluid conduit 70 extends through the cover 60 into the fluid reservoir. The fluid conduit 70 passes through a fluid pump and heater unit 72 and connects with a central channel 74 defined within the shaft 66 of the paddle 62. Fluid enters the basin 40 through a plurality of openings 76 communicating between the exterior of the shaft 66 and the channel 74.

An electronic control unit 80 is also arranged within the housing 12. The electronic control unit 80 is operable to receive inputs from, and supply indications to the control section 20. The electronic control unit 80 is also operable to control the heating element 52 paddle motor 64, pump and heater unit 72 and other components, as desired.

Referring to FIGS. 1 and 2, in operation of the hot cereal maker 10, a user raises the lid 16 and detaches the paddle 62, if attached. The user inserts a disposable liner 46, having a quantity of cereal grains corresponding to a desired number of hot cereal servings therein, into the cooking vessel 42. If the cooking vessel 42 is removed, the user inserts the cooking vessel 42 and the disposable liner 46. The user also ensures that the fluid reservoir 54 contains sufficient fluid 56 for the desired number of hot cereal servings.

The user attaches the paddle 62 and lowers the lid 16 so that the cover 60 closes the basin 40. Preferably, lowering the lid 16 automatically jogs the paddle 62, for example under the command of the electronic control unit 80 or due to a mechanical connection between the sleeves or legs 30, 32 and the paddle 62. Jogging the paddle 62 facilitates advancement of the paddle 62 through the cereal grains in the basin 40.

Using the control section 20, the user sets a number of servings, preferably corresponding to the desired number of servings. The user can select to start the maker 10 immediately, or set a predetermined start time in the future. When the maker 10 starts, either based on user selection of immediate starting or after the predetermined start time is reached, the electronic control unit 80 operates the pump and heater unit 72 to energize and pump and heat fluid from the reservoir 54, through the conduit 70, to the channel 74 and into the basin 40. The electronic control unit 80 also operates the paddle motor 64 to rotate the paddle 62, stirring the cereal grains and fluid for a predetermined cycle. The amount of fluid pumped into the basin and the duration and characteristics of the predetermined cycle are preferably based on the set number of servings.

When the cycle is finished and the hot cereal is ready, the electronic control unit 80 indicates that the hot cereal is ready, for instance by flashing the display or generating an audible indication. During the cycle and after the hot cereal is ready, the electronic control unit 80 operates the heating element 52 to maintain the hot cereal in the basin 40 at a predetermined temperature.

When the hot cereal is ready, the user slides the lid 16 upward to open the basin 40. As with closing the lid 16, opening the lid 16 preferably automatically jogs the paddle 62, facilitating clean withdrawal. The user detaches the paddle 62 and removes the disposable liner 46, either separately or in conjunction with the cooking vessel 42. The user can wash the paddle 62, consumer the hot cereal, and the hot cereal maker 10 is ready for another use.

From the foregoing, it will be appreciated that the present invention provides a hot cereal maker that allows a compact configuration and can be loaded in advance with cereal grains and fluid, allowing a future start time to be preset without concern over over-soaking of the grains. The present invention also offers a paddle that can be completely removed from the hot cereal and facilitates that removal with automatic jogging of the paddle. Moreover, the channel and fluid openings in the paddle allow fast and even distribution of fluid into cereal grains, reducing concern of overflowing the basin.

The present invention is not necessarily limited to the embodiment herein shown and described. Instead, those skilled in the art will appreciate that various features, aspects and advantages of the present invention are applicable in other applications, and that numerous modifications, and adaptations to particular circumstances, are possible within the scope of the present invention.

For instance, housings of other shapes, sizes and configurations can be employed within the scope of the present invention, including housings that form only partial enclosures or incorporate two or more distinct components. Additionally, control sections can be located elsewhere on the housing, could allow for remote control, control over a network, and other control types, and can incorporate displays and controls other than, or in addition to, the particular displays, lights or controls shown and described herein.

Also, other numbers and configurations of legs and sleeves can be employed to slidably connect the lid 16 with the base 14. Alternately, the lid 16 could be completely removable from the base 14, hinged relative to the base, or connected in other fashions.

Additionally, other shapes and configurations of basins can be employed, and used with or without cooking vessels or liners. Various numbers or configurations of protrusions can be used, or protrusions can be omitted where appropriate. Other heating elements can also be employed, for instance, solid or fluid filled heating jackets or heating coils surrounding the basin.

Other shapes and configurations of paddles are also possible within the scope of the present invention, as well as various mechanisms for allowing releasable connection of the paddle. If desired, the paddle can also be permanently connected. Additionally, various integral or separate pump and heater units can be employed to transport fluid. An external fluid reservoir or fluid source can also be employed, or fluid can be manually added, in connection with various aspects of the present invention.

Moreover, aspects of the present invention can be employed in applications other than hot cereal makers or the preparation of foodstuffs. Additionally, in the context of hot cereals, both instant hot cereals and uncooked hot cereals can bed used, for example, by including an instant cereal selection to adapt the cycle for the use of instant hot cereal.

The foregoing is not an exclusive list of possible modifications, variations or adaptations. Instead, those skilled in the art will appreciate that these and other changes are possible within the scope of the invention as herein shown and described.

What is claimed is:

1. A hot cereal maker comprising:
a housing with a basin defined therein for accommodating cereal grains; and
a paddle disposed within the housing and operable to mix the cereal grains;
wherein the housing includes a base and a lid movable relative thereto, the basin being defined within the base and the paddle being connected to the lid.

2. The hot cereal maker of claim 1, wherein the paddle is detachably connected to the lid.

3. The hot cereal maker of claim 1, wherein the paddle has a channel, and at least one opening extending between the channel and the basin, defined therein.

4. The hot cereal maker of claim 3, wherein the paddle has a plurality of openings extending between the channel and the basin defined therein.

5. The hot cereal maker of claim 1, wherein the basin also has a fluid reservoir defined therein, the fluid reservoir being in fluid communication with the basin.

6. The hot cereal maker of claim 5, wherein the fluid reservoir is in fluid communication with the basin through a channel formed in the paddle.

7. The hot cereal maker of claim 1, wherein the lid is slidable relative to the base between raised and lowered positions.

8. The hot cereal maker of claim 7, wherein the hot cereal maker is adapted to automatically jog the paddle when raising or lowering the lid.

9. The hot cereal maker of claim 8, wherein the hot cereal maker is adapted to automatically jog the paddle when raising and lowering the lid.

10. The hot cereal maker of claim 1, further comprising a cooking vessel removably disposed within the basin.

11. The hot cereal maker of claim 10, further comprising at least one protrusion extending from the basin and engaging the cooking vessel to prevent rotation of the cooking vessel within the basin.

12. The hot cereal maker of claim 10, further comprising a liner removably arranged within the cooking vessel.

13. A mixing apparatus comprising:
a housing having a basin defined therein;
a paddle disposed within the basin having a channel, and at least one opening communicating between the channel and the basin, defined therein; and
a fluid conduit for supplying fluid from a fluid source to the channel defined within the paddle.

14. The apparatus of claim 13, wherein the paddle has a plurality of openings communicating between the channel and the basin defined therein.

15. The apparatus of claim 13, further comprising the fluid source.

16. The apparatus of claim 15, wherein the fluid source is a fluid reservoir defined within the housing.

17. The apparatus of claim 13, wherein the housing and the paddle are arranged to allow relative rotational movement therebetween.

18. The apparatus of claim 13, wherein the paddle is removable.

19. The apparatus of claim 13, wherein the housing includes a lid and base, the paddle being connected to the lid and the basin being defined within the base.

20. A mixing paddle comprising:
a shaft having a channel defined centrally therein and a plurality of openings extending through the shaft to the channel also defined therein; and
at least one vane extending from the shaft.

21. The mixing paddle of claim 20, further comprising a plurality of vanes extending from the shaft.

22. The mixing paddle of claim 20, wherein an end of the shaft is adapted for releasable connection with a motor.
